(19) United States
(12) Patent Application Publication
(10) Pub. No.: US 2011/0154393 A1
(43) Pub. Date: Jun. 23, 2011

(54) IPTV SET-TOP BOX AND CHANNEL SWITCHING METHOD THEREOF

(75) Inventor: Sang-Jung RA, Daejeon (KR)

(73) Assignee: Electronics and Telecommunications Research Institute, Daejeon (KR)

(21) Appl. No.: 12/889,033

(22) Filed: Sep. 23, 2010

(30) Foreign Application Priority Data
Dec. 21, 2009 (KR) 10-2009-0128075

(51) Int. Cl. H04N 7/173; H04N 7/025

(52) U.S. Cl. 725/35; 725/110

(57) ABSTRACT

An Internet Protocol Television (IPTV) Set-Top Box (STB) is provided to efficiently use a time gap caused by a channel switching. The IPTV STB may request a network switch to perform a channel switching operation so that a national service broadcast stream of a second channel is received, when a channel selection signal for the second channel is received while a national service broadcast stream of a first channel is received. Additionally, the IPTV STB may transmit a local service broadcast stream received from a broadcast stream receiver to a display device.

### CROSS-REFERENCE TO RELATED APPLICATION

This application claims the benefit of Korean Patent Application No. 10-2009-0128075, filed on Dec. 21, 2009, in the Korean Intellectual Property Office, the disclosure of which is incorporated herein by reference.

### BACKGROUND

1. Field of the Invention

The present invention relates to an Internet Protocol Television (IPTV) Set-Top Box (STB) and a channel switching method thereof that may efficiently use a time gap occurring during a channel switching.

2. Description of the Related Art

Internet Protocol Television (IPTV) systems refer to apparatuses for receiving, via an Internet Protocol (IP)-based network, services such as information services, moving image contents, or broadcast contents. Such IPTV systems are a type of digital convergence, namely, a convergence of the Internet and TVs.

When using an IPTV system, users experience inconvenience due to a zapping time. The zapping time refers to a time gap during which a broadcast service is received from a channel via a network, is decoded, and is displayed when a subscriber switches a channel. Since a screen remains blank, and the channel is slowly switched during the zapping time, the subscriber may feel bored.

Additionally, the zapping time is expected to further increase when a high quality broadcast service, such as a three-dimensional (3D) service or an Ultra High Definition (UHD) service that will be provided in the future, is received. Thus, there is a desire for a method to mitigate problems of a time gap so that a subscriber may not feel inconvenience or bored during channel switching.

### SUMMARY

An aspect of the present invention provides an Internet Protocol Television (IPTV) Set-Top Box (STB) and a channel switching method thereof that may receive a local service broadcast stream, and may display the received local service broadcast stream during a time gap occurring when a channel is switched.

According to an aspect of the present invention, there is provided an IPTV STB including a broadcast stream receiver to connect to a network switch, and to receive, from the network switch, a national service broadcast stream and a local service broadcast stream; a channel switching request processor to request the network switch to perform a channel switching operation so that a national service broadcast stream of a second channel is received, when a channel selection signal for the second channel is received while a national service broadcast stream of a first channel is received; and a broadcast stream transmitter to transmit the local service broadcast stream to a display device, the local service broadcast stream being received from the broadcast stream receiver during the channel switching operation.

According to another aspect of the present invention, there is provided a channel switching method of an IPTV STB including receiving a national service broadcast stream of a first channel through a network switch; requesting the network switch to perform a channel switching operation so that a national service broadcast stream of a second channel is received, when a channel selection signal for the second channel is received; receiving a local service broadcast stream from the network switch during the channel switching operation; and transmitting the local service broadcast stream to a display device.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating an Internet Protocol Television (IPTV) system according to an embodiment of the present invention;

FIG. 2 is a block diagram illustrating a configuration of an IPTV Set-Top Box (STB) according to an embodiment of the present invention;

FIG. 3 is a diagram illustrating a structure of an Internet Group Management Protocol (IGMP) message according to an embodiment of the present invention;

FIG. 4 is a flowchart illustrating a channel switching method of an IPTV STB according to an embodiment of the present invention; and

FIG. 5 is a flowchart further illustrating an operation of requesting a channel switching in an IPTV STB according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

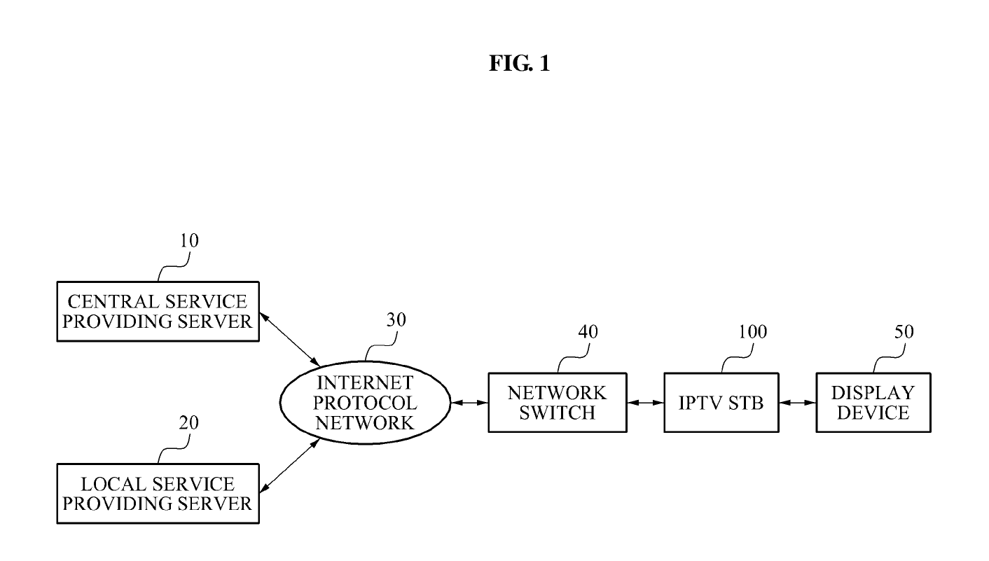

FIG. 1 is a diagram illustrating an Internet Protocol Television (IPTV) system according to an embodiment of the present invention. Referring to FIG. 1, the IPTV system includes a network switch 40, an IPTV Set-Top Box (STB) 100, and a display device 50.

The network switch 40 may connect to an Internet Protocol (IP)-based network 30, and may be linked with a central service providing server 10 and a local service providing server 20. The network switch 40 may receive national service broadcast streams of all channels from the central service providing server 10, and may receive local service broadcast streams from the local service providing server 20. Here, the national service broadcast streams may be associated with pay services provided by the central service providing server 10 to all nationwide subscribers, and the local service broadcast streams may be provided to subscribers residing in a specific local area. The local service broadcast streams may be associated with free and public services available for all subscribers residing in a specific local area, not pay services.

For example, when a subscriber resides in an area “A,” the subscriber may view a broadcast stream corresponding to local broadcast information, local advertisement information, and local public information that are associated with the area “A.”

The network switch 40 may transmit, to the IPTV STB 100, only a national service broadcast stream of a specific channel that is requested by the IPTV STB 100, among the national service broadcast streams received from the central service providing server 10. When a request to switch a current channel to another channel is received from the IPTV STB 100, the network switch 40 may transmit a national service broadcast stream of the other channel to the IPTV STB 100.

Additionally, the network switch 40 may transmit, to the IPTV STB 100, the local service broadcast streams received from the local service providing server 20.

The IPTV STB 100 may receive various broadcast streams and program guide information for multiple channels, and may transmit the received broadcast streams and program guide information to the display device 50. In particular, the IPTV STB 100 may transmit, to the display device 50, a national service broadcast stream of a specific channel or a local service broadcast stream that is received from the network switch 40.

When a national service broadcast stream of a first channel is being received, and when a channel selection signal for a second channel is received from a subscriber, the IPTV STB 100 may perform a channel switching operation to receive a national service broadcast stream of the second channel and to transmit the received national service broadcast stream to the display device 50. Here, the channel switching operation may include all steps by which the IPTV STB 100 receives the national service broadcast stream of the second channel from the network switch 40 in response to the channel selection signal for the second channel and transmits the received national service broadcast stream to the display device 50.

To receive the national service broadcast stream of the second channel, the IPTV STB 100 may transmit an Internet Group Management Protocol (IGMP) message to the network switch 40, and may request the channel switching operation. Specifically, the IPTV STB 100 may generate an IGMP leave message to stop a reception of the national service broadcast stream of the first channel, and may transmit the generated IGMP leave message to the network switch 40. Also, the IPTV STB 100 may generate an IGMP join message to request the national service broadcast stream of the second channel, and may transmit the generated IGMP join message to the network switch 40. Here, the IGMP join message may contain information regarding a maximum resolution supported by the display device 50.

The network switch 40 may sequentially receive the IGMP leave message and the IGMP join message, may stop a transmission of the national service broadcast stream of the first channel, and may transmit the national service broadcast stream of the second channel to the IPTV STB 100. Accordingly, the IPTV STB 100 may receive the national service broadcast stream of the second channel from the network switch 40, and may separate the received national service broadcast stream of the second channel for each resolution. Here, the national service broadcast stream of the second channel may have a collection of broadcast streams with a Standard Definition (SD) resolution, a High Definition (HD) resolution, an Ultra Definition (UD) resolution, and a three-dimensional (3D) resolution. In other words, the national service broadcast stream of the second channel may be separated by the SD resolution, the HD resolution, the UD resolution, and the 3D resolution.

The IPTV STB 100 may decode a broadcast stream corresponding to the information regarding the maximum resolution contained in the IGMP join message among the separated national service broadcast stream, and may transmit the decoded broadcast stream to the display device 50. When the channel switching operation is completed, the IPTV STB 100 may stop a transmission of the local service broadcast stream.

Since a predetermined period of time is required to perform the channel switching operation as described above, a time gap may occur. Specifically, during the channel switching operation, the IPTV STB 100 may receive the local service broadcast stream from the network switch 40, and may transmit the received local service broadcast stream to the display device 50. The display device 50 may output the received local service broadcast stream during the time gap caused by the channel switching operation. Accordingly, a subscriber may view one of local broadcast information, local advertisement information, and local public information during the time gap. In other words, the time gap may be efficiently used.

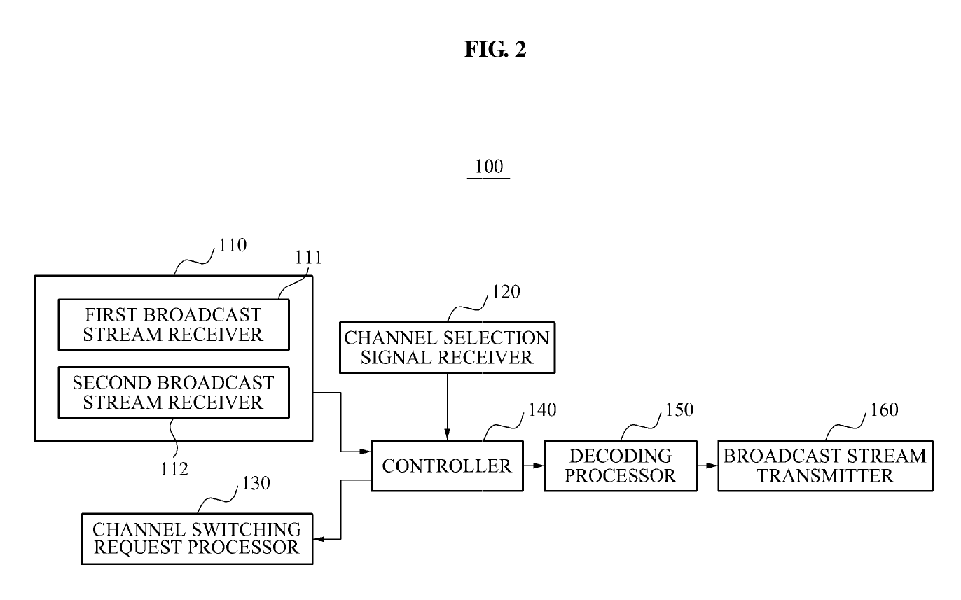

FIG. 2 is a block diagram illustrating a configuration of an IPTV STB 100 according to an embodiment of the present invention. Referring to FIG. 2, the IPTV STB 100 includes a broadcast stream receiver 110, a channel selection signal receiver 120, a channel switching request processor 130, a controller 140, a decoding processor 150, and a broadcast stream transmitter 160.

The broadcast stream receiver 110 may connect to the network switch 40, and may receive, from the network switch 40, a national service broadcast stream and a local service broadcast stream. The broadcast stream receiver 110 may include a first broadcast stream receiver 111 configured to receive the national service broadcast stream, and a second broadcast stream receiver 112 configured to receive the local service broadcast stream.

The channel selection signal receiver 120 may receive a channel selection signal. For example, when a subscriber enters a channel number or presses a channel up and down button by manipulating a remote controller, the channel selection signal receiver 120 may receive a channel selection signal corresponding to a subscriber's manipulation of the remote controller. Additionally, the channel selection signal receiver 120 may receive a channel selection signal through the display device 50, not directly from the remote controller.

The channel switching request processor 130 may connect to the network switch 40, and may request channel switching. Specifically, when a national service broadcast stream of a first channel is being received by the first broadcast stream receiver 111, and when a channel selection signal for a second channel is received, the channel switching request processor 130 may receive a national service broadcast stream of the second channel from the network switch 40, and may perform the channel switching operation to transmit the received national service broadcast stream of the second channel to the display device 50. Here, the channel switching request processor 130 may send a channel switching request to the network switch 40, so that the network switch 40 may perform the channel switching operation.

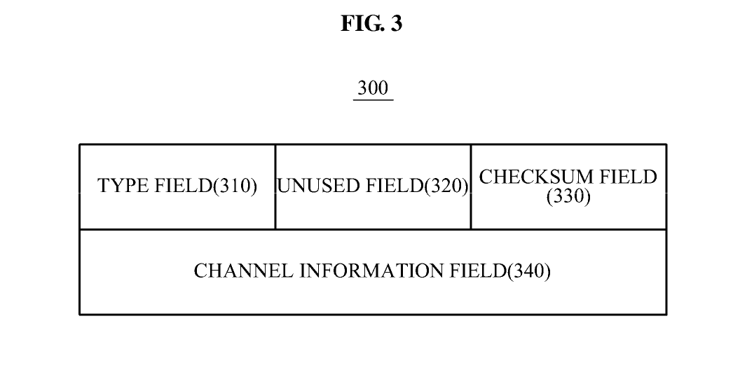

More specifically, the channel switching request processor 130 may generate an IGMP message and transmit the generated IGMP message to the network switch 40, to request the network device 40 to switch to the second channel. Here, the IGMP message may include an IGMP leave message to stop a reception of the national service broadcast stream of the first channel, and an IGMP join message to request the national service broadcast stream of the second channel. While generating the IGMP join message, the channel switching request processor 130 may check the information regarding the maximum resolution supported by the display device 50. Additionally, the channel switching request processor 130 may determine a resolution identifier (ID) corresponding to the information regarding the maximum resolution, and may record the determined resolution ID in an unused field of the IGMP join message. A further description of the IGMP join message will be described with reference to FIG. 3 below.

The decoding processor 150 may decode a broadcast stream received by the first broadcast stream receiver 111 or the second broadcast stream receiver 112. The broadcast stream transmitter 160 may transmit the decoded broadcast stream to the display device 50.

The controller 140 may control an overall operation of the IPTV STB 100. Specifically, when a channel selection signal is received by the channel selection signal receiver 120, the controller 140 may control the channel switching request processor 130 to request switching to a channel corresponding to the channel selection signal.

Additionally, when the channel selection signal is received, the controller 140 may receive the local service broadcast stream through the second broadcast stream receiver 112, and may control the received local service broadcast stream to be transmitted to the display device 50 through the decoding processor 150 and the broadcast stream transmitter 160.

When the national service broadcast stream of the second channel is received through the first broadcast stream receiver 111 in response to a channel switching request, the controller 140 may control the decoding processor 150 to decode the received national service broadcast stream of the second channel. Under the control of the controller 140, the decoding processor 150 may separate the received national service broadcast stream of the second channel for each resolution, and may decode a broadcast stream with a resolution indicated by the resolution ID recorded in the unused field of the IGMP join message among the national service broadcast stream of the second channel.

Additionally, the controller 140 may stop the transmission of the local service broadcast stream, and may control the broadcast stream transmitter 160 to transmit the decoded national service broadcast stream of the second channel to the display device 50.

The IPTV STB 100 of FIG. 2 may transmit the local service broadcast stream to the display device 50 during the time gap occurring in the channel switching operation, so that the time gap may be efficiently used.

FIG. 3 is a diagram illustrating a structure of an IGMP message 300 according to an embodiment of the present invention. The IGMP message 300 of FIG. 3 may be generated when the IPTV STB 100 requests the network switch 40 to perform the channel switching operation in response to a channel selection signal.

Referring to FIG. 3, the IGMP message 300 typically includes a type field 310, an unused field 320, and a checksum field 330. Additionally, the IGMP message 300 may further include a channel information field 340.

For example, when a value indicating a previous channel before channel switching is recorded in the channel information field 340, the IGMP message 300 may be used as an IGMP leave message. When a value indicating a channel to be switched is recorded in the channel information field 340, the IGMP message 300 may be used as an IGMP join message.

In this example, when the IGMP message 300 is used as an IGMP leave message, a value of the type field 310 may be set to be “0×17.” When the IGMP message 300 is used as an IGMP join message, a value of the type field 310 may be set to be “0×16.”

In other words, when a value of the type field 310 in the IGMP message 300 is set to be “0×17,” and when the channel information field 340 contains information on a “channel 1,” the network switch 40 may determine that the IPTV STB 100 is to immediately request the channel switching operation even when a broadcast stream of the “channel 1” is currently received. Subsequently, when a value of the type field 310 in the IGMP message 300 is set to be “0×16,” and when the channel information field 340 contains information on a “channel 2,” the network switch 40 may determine that the IPTV STB 100 may request switching to the “channel 2.”

When the IGMP message 300 of FIG. 3 is used as an IGMP join message, the unused field 320 may contain specification information of the display device 50 that is to receive a broadcast stream of a channel to be switched. For example, the unused field 320 may include information regarding a maximum resolution displayable by the display device 50. Specifically, when the display device 50 enables a display of a broadcast content with a 3D resolution, the unused field 320 may contain a value of “00000100.” Additionally, when the display device 50 enables a display of a broadcast content with an SD resolution, the unused field 320 may contain a value of “0000001.” When the display device 50 enables a display of a broadcast content with an HD resolution, the unused field 320 may contain a value of “00000010.”

In other words, the IPTV STB 100 may check the information regarding the maximum resolution supported by the display device 50, may determine a resolution ID corresponding to the information regarding the maximum resolution, and may record the determined resolution ID in the unused field 320. Also, the IPTV STB 100 may store the generated IGMP join message in a storage medium.

The checksum field 330 may be used to detect a typical error in the IGMP message 300.

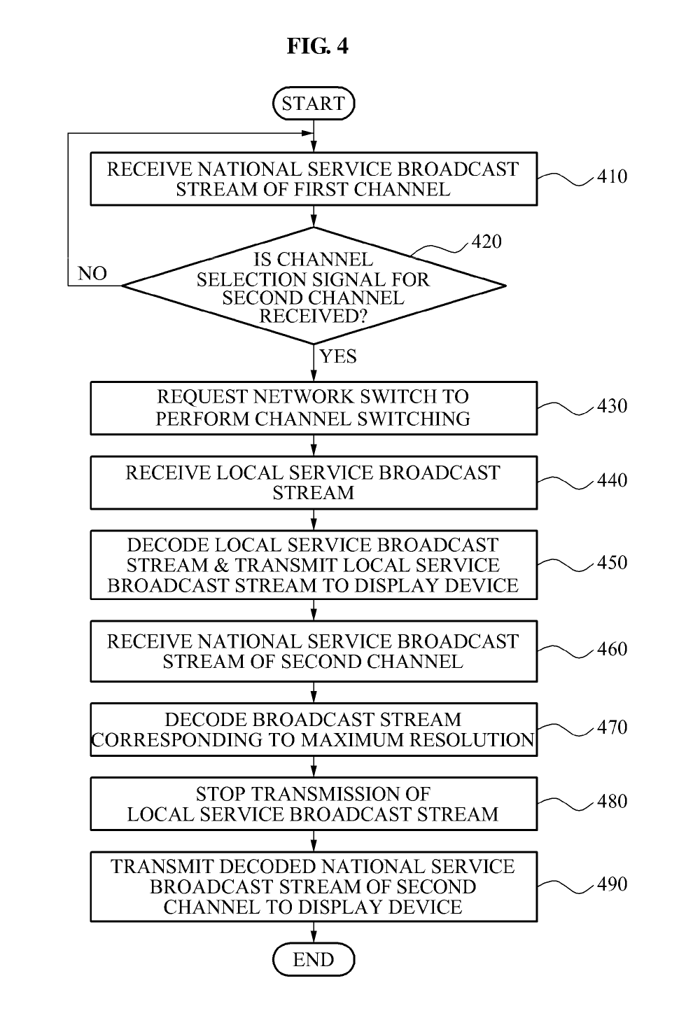

FIG. 4 is a flowchart illustrating a channel switching method of the IPTV STB 100 according to an embodiment of the present invention. Referring to FIG. 4, in operation 410, the IPTV STB 100 may receive a national service broadcast stream of a first channel. Here, the IPTV STB 100 may decode the received national service broadcast stream of the first channel, and may transmit the decoded national service broadcast stream to the display device 50.

When a channel selection signal for a second channel is received while the national service broadcast stream of the first channel is received in operation 420, the IPTV STB 100 may request the network switch 40 to perform a channel switching operation in operation 430.

Here, the channel switching operation may include all steps by which the IPTV STB 100 receives a national service broadcast stream of the second channel from the network switch 40 in response to the channel selection signal for the second channel and transmits the received national service broadcast stream to the display device 50.

In operation 440, the IPTV STB 100 may receive a local service broadcast stream from the network switch 40 during the channel switching operation. In operation 450, the IPTV STB 100 may decode the received local service broadcast stream, and may transmit the decoded local service broadcast stream to the display device 50. Specifically, when the channel selection signal for the second channel is received, the IPTV STB 100 may request the network switch 40 to transmit the local service broadcast stream, and may receive the local service broadcast stream. Alternatively, when channel selection signal for the second channel is received while the local service broadcast stream is received, the IPTV STB 100 may decode the received local service broadcast stream, and may transmit the decoded local service broadcast stream to the display device 50.

Since a time gap occurs due to the channel switching operation while the IPTV STB 100 performs the channel switching operation, the IPTV STB 100 may provide a subscriber with the local service broadcast stream during the time gap. Accordingly, the subscriber may view one of local broadcast information, local advertisement information, and local public information during the time gap, instead of viewing a blank screen.

When the national service broadcast stream of the second channel is received from the network switch 40 in operation 460, the IPTV STB 100 may decode a broadcast stream corresponding to the information regarding the maximum resolution supported by the display device 50 in operation 470. Specifically, the national service broadcast stream of the second channel may be combination data of broadcast streams having various resolutions for a same channel, and may be separated for each resolution. The IPTV STB 100 may select the broadcast stream corresponding to the information regarding the maximum resolution supported by the display device 50 from among the national service broadcast stream of the second channel, and may decode the selected broadcast stream. For example, when a 3D resolution is supported by the display device 50, the IPTV STB 100 may decode a broadcast stream having the 3D resolution among the national service broadcast stream of the second channel. In this example, the 3D resolution, namely, the maximum resolution supported by the display device 50 may be recorded in an unused field of an IGMP join message.

In operation 480, the IPTV STB 100 may stop a transmission of the local service broadcast stream to the display device 50. In operation 490, the IPTV STB 100 may transmit the decoded national service broadcast stream of the second channel to the display device 50.

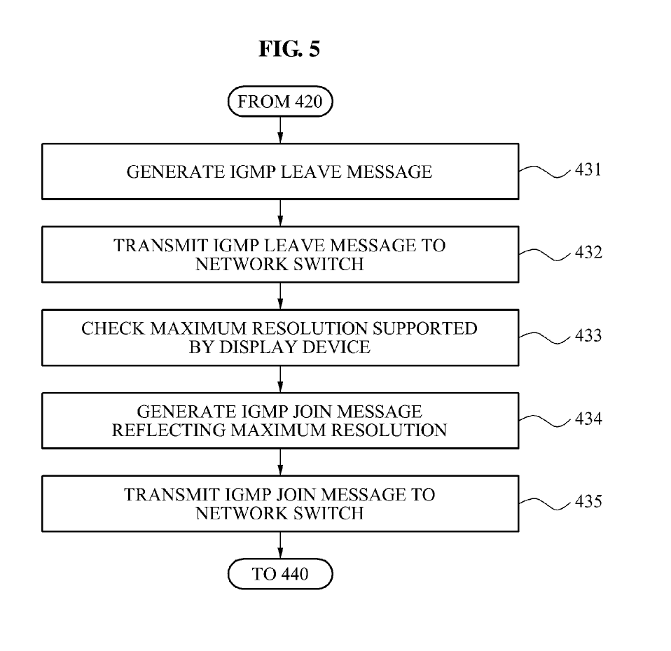

FIG. 5 is a flowchart further illustrating an operation of requesting a channel switching in an IPTV STB according to an embodiment of the present invention. To further describe operation 430 of FIG. 4, operations 431 through 435 of FIG. 5 may be provided.

In operation 431, the IPTV STB 100 may generate an IGMP leave message, in response to the channel selection signal for the second channel. Here, the IGMP leave message may be used to stop a reception of the national service broadcast stream of the first channel.

In operation 432, the IPTV STB 100 may transmit the IGMP leave message to the network switch 40. The network switch 40 may receive the IGMP leave message, and may stop a transmission of the national service broadcast stream of the first channel to the IPTV STB 100.

In operation 433, the IPTV STB 100 may check the information regarding the maximum resolution supported by the display device 50. In operation 434, the IPTV STB 100 may generate an IGMP join message reflecting the information regarding the maximum resolution. Here, the IGMP join message may be used to request a reception of the national service broadcast stream of the second channel, and the information regarding the maximum resolution may be recorded in the unused field of the IGMP join message.

In operation 435, the IPTV STB 100 may transmit the IGMP join message to the network switch 40. Specifically, in operation 435, the IPTV STB 100 may send a channel switching request to the network switch 40, and the network switch 40 may transmit the national service broadcast stream of the second channel to the IPTV STB 100 in response to the channel switching request.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. An Internet Protocol Television (IPTV) Set-Top Box (STB), comprising:
a broadcast stream receiver to connect to a network switch, and to receive, from the network switch, a national service broadcast stream and a local service broadcast stream;
a channel switching request processor to request the network switch to perform a channel switching operation so that a national service broadcast stream of a second channel is received, when a channel selection signal for the second channel is received while a national service broadcast stream of a first channel is received; and
a broadcast stream transmitter to transmit the local service broadcast stream to a display device, the local service broadcast stream being received from the broadcast stream receiver during the channel switching operation.

2. The IPTV STB of claim 1, wherein the local service broadcast stream comprises a broadcast stream regarding one of local broadcast information, local advertisement information, and local public information.

3. The IPTV STB of claim 2, wherein the channel switching request processor generates an Internet Group Management Protocol (IGMP) leave message used to stop a reception of the national service broadcast stream of the first channel, transmits the generated IGMP leave message to the network switch, generates an IGMP join message corresponding to the channel selection signal, transmits the generated IGMP join message to the network switch, and requests the channel switching operation.

4. The IPTV STB of claim 3, wherein the channel switching request processor checks information regarding a maximum resolution supported by the display device, and generates the IGMP join message reflecting the maximum resolution.

5. The IPTV STB of claim 4, wherein the channel switching request processor determines a resolution identifier (ID) corresponding to the information regarding the maximum resolution, and records the determined resolution ID in an unused field of the IGMP join message.

6. The IPTV STB of claim 5, further comprising:
a decoding processor to separate the national service broadcast stream of the second channel for each resolution, and to decode a national service broadcast stream having a resolution corresponding to the resolution ID recorded in the unused field of the IGMP join message among the separated national service broadcast stream, the national service broadcast stream of the second channel being received by the broadcast stream receiver.

7. The IPTV STB of claim 6, wherein the broadcast stream transmitter stops a transmission of the local service broadcast stream, and transmits the decoded national service broadcast stream of the second channel to the display device.

8. A channel switching method, comprising:
receiving a national service broadcast stream of a first channel through a network switch;
requesting the network switch to perform a channel switching operation so that a national service broadcast stream of a second channel is received, when a channel selection signal for the second channel is received;
receiving a local service broadcast stream from the network switch during the channel switching operation; and
transmitting the local service broadcast stream to a display device.

9. The channel switching method of claim 8, further comprising:
stopping a transmission of the local service broadcast stream, and transmitting the national service broadcast stream of the second channel to the display device, when the channel switching operation is completed.

10. The channel switching method of claim 8, wherein the local service broadcast stream comprises a broadcast stream regarding one of local broadcast information, local advertisement information, and local public information.

11. The channel switching method of claim 8, wherein the requesting comprises:
generating an IGMP leave message, and transmitting the generated IGMP leave message to the network switch, the IGMP leave message being used to stop a reception of the national service broadcast stream of the first channel;
generating an IGMP join message corresponding to the channel selection signal; and
transmitting the generated IGMP join message to the network switch, and requesting the channel switching operation.

12. The channel switching method of claim 11, wherein the generating of the IGMP join message comprises checking information regarding a maximum resolution supported by the display device, and generating the IGMP join message reflecting the maximum resolution.

13. The channel switching method of claim 12, wherein the generating of the IGMP join message further comprises determining a resolution ID corresponding to the information regarding the maximum resolution, and recording the determined resolution ID in an unused field of the IGMP join message.

14. The channel switching method of claim 13, further comprising:
separating the national service broadcast stream of the second channel for each resolution, decoding a national service broadcast stream having a resolution corresponding to the resolution ID recorded in the unused field of the IGMP join message among the separated national service broadcast stream, and transmitting the decoded broadcast stream to the network device, when the national service broadcast stream of the second channel is received.
